(19) United States
(12) Patent Application Publication
(10) Pub. No.: US 2011/0058255 A1
(43) Pub. Date: Mar. 10, 2011

(54) COMPUTER, PDA OR TELEPHONE LENS COVER

(76) Inventor: David G. Weiss, Atherton, CA (US)

(21) Appl. No.: 12/991,175

(22) PCT Filed: May 6, 2009
(86) PCT No.: PCT/US09/43013

§ 371 Date: Nov. 5, 2010

Related U.S. Application Data
(60) Provisional application No. 61/051,056, filed on May 7, 2008.
(60) Provisional application No. 61/054,687, filed on May 20, 2008.

(51) Int. Cl. G02B 23/16

(52) U.S. Cl. 359/511

(57) ABSTRACT

A lens cover covers a camera lens or a projection lens formed in the frame of a computer display or in the body of a personal digital assistant or mobile telephone. The cover is movable to allow the lens to operate, yet allow the cover to remain with the device. One cover pivots around a pivot point to cover or uncover the lens. Another cover hinges in order to cover or uncover the lens. Another cover slides back and forth. Another cover hangs upon a hook located above the lens. Another cover is a suction cup applied over the lens. Another cover slides back and forth hanging on the top edge of the computer display. The cover may be fixed in place using gravity, friction, a snap, hook and loop closures, suction, or a ZIPLOC-type mechanism. The cover or its attaching means may be fixed to the computer or telephone using a self adhesive.

### CROSS-REFERENCE TO RELATED APPLICATIONS

This application claims priority of U.S. provisional patent applications No. 61/051,056 filed May 7, 2008 and No. 61/054,687 filed May 20, 2008, both entitled “Computer Camera and Webcam Cover,” and which are hereby incorporated by reference.

### FIELD OF THE INVENTION

The present invention relates generally to computing devices and cameras. More specifically, the present invention relates to a cover for a camera or projector typically found on computing devices and mobile telephones.

### BACKGROUND OF THE INVENTION

Many desktop and laptop computers these days have a small camera lens integrated into the frame of the display or monitor of these computers. The camera lens may then be easily used by the user of the computer to take a picture of himself or herself, or to transmit still or video images while sitting in front of the computer. The ease of use of such a camera lens can also be a drawback, though. A user may not realize that the camera is on and may inadvertently step photographs or transmit still or video images over a network to another location without realizing it.

Most mobile telephones now also include a camera lens on their back surfaces (in the case of so-called “candy bar” telephones) allowing a user to snap a photograph while holding the camera. Flip telephones typically include the camera lens on their front surfaces (when closed) so that the camera is in position to take a photograph when the flip telephone is in an open position. More sophisticated devices such as smart telephones and personal digital assistants (PDAs) also include a camera lens on their back surfaces. Similar to the camera in a computer, the user may inadvertently take a photograph or take a movie without knowing it.

In addition to a computer, PDA or mobile telephone including a camera lens for taking photographs, many of these devices are beginning to include a projection lens for projecting a still or video image onto a nearby surface. But, an image may be inadvertently projected because the user may not know that the device is on.

While many of these devices include an on/off button, a warning light or other visual indicator, the user may still be unaware that the camera lens is taking a picture or the projection lens is projecting an image. Therefore, a device is needed to assure the user that the lens cannot operate when the user does not wish it to operate, and to provide a concrete visual indicator that the lens cannot operate. Further, such a device should be simple and sturdy.

### SUMMARY OF THE INVENTION

To achieve the foregoing, and in accordance with the purpose of the present invention, a camera cover is disclosed that mounts over a camera typically found on computers and telephones such that the camera is covered.

The cover may have a shape of a square, round, triangular or oval door or lid that attaches over the built-in camera on computers, laptops, mobile telephones, smart telephones, personal digital assistants, web cameras, etc. It can be open or closed by hand. The exterior may be covered in many different colors as well as with logos and various designs. The cover serves many purposes such as advertising, camera lens protection, and privacy. When the cover is opaque, the camera cannot view objects when the cover is closed, or may not be able to view them clearly. Alternatively, the cover may be translucent in which case although an image may be viewed or transmitted, the image will not be clear.

In one embodiment, the cover covers a projection lens of a computer, PDA or mobile telephone. Normally the projection lens is used to project an image or video, but when the cover is closed no projection can occur. If the cover is translucent a distorted image or video would be displayed but would not be recognizable.

The cover may be made from a wide variety of materials such as metal, plastic, wood, KEVLAR, vinyl, neoprene, paper, cardboard, recycled materials, etc. In various embodiments, the cover may attach via a self-adhesive backing onto the computer or telephone, clip onto a recessed area of the camera, clip onto the computer display, clip over the camera lens, etc. The size of the cover may range from just large enough to cover the camera or projection lens itself, just large enough to cover the recessed area in which the lens sits, or large enough to easily cover the entire recessed area.

As described below, it will be appreciated that the cover may be closed or stay closed using its own weight (gravity), hook-and-loop closures such as VELCRO, snaps, a latch, friction, suction, a zipper or a ZIPLOC-type closure.

### BRIEF DESCRIPTION OF THE DRAWINGS

The invention, together with further advantages thereof, may best be understood by reference to the following description taken in conjunction with the accompanying drawings in which:

FIG. 1 illustrates a computer onto which the cover of the present invention may be mounted.

FIG. 2 illustrates a personal digital assistant (PDA) or smart telephone (“smart phone”) onto which the cover of the present invention may be mounted.

FIG. 3 illustrates a mobile telephone onto which the cover of the present invention may be mounted.

FIGS. 4A and 4B illustrate a first embodiment of the cover of the present invention in which it pivots in order to cover the lens.

FIG. 5 illustrates a second embodiment in which the cover is mounted upon a mobile telephone.

FIGS. 6A, 6B and 6C illustrate a third embodiment in which the cover hinges in order to cover the lens.

FIGS. 7A and 7B illustrate a fourth embodiment in which the cover hinges to cover the lens.

FIGS. 8A and 8B illustrate a fifth embodiment in which the cover hinges to cover the lens.

FIGS. 9A and 9B illustrate a sixth embodiment in which the cover slides back and forth in order to cover the lens.

FIGS. 10A and 10B illustrate a seventh embodiment in which the cover is fixed in place using a snap.

FIGS. 11A and 11B illustrate an eighth embodiment in which the cover mounts on a hook or pin.

FIGS. 12A and 12B illustrate a ninth embodiment in which the cover mounts via a suction cup.

FIGS. 13A and 13B illustrate a tenth embodiment in which the cover slides on top of the computer.

FIGS. 14A and 14B illustrate an 11th embodiment in which the cover is fixed in place using a ZIPLOC-type closure.

### DETAILED DESCRIPTION OF THE INVENTION

### Devices Suitable for Use with the Cover

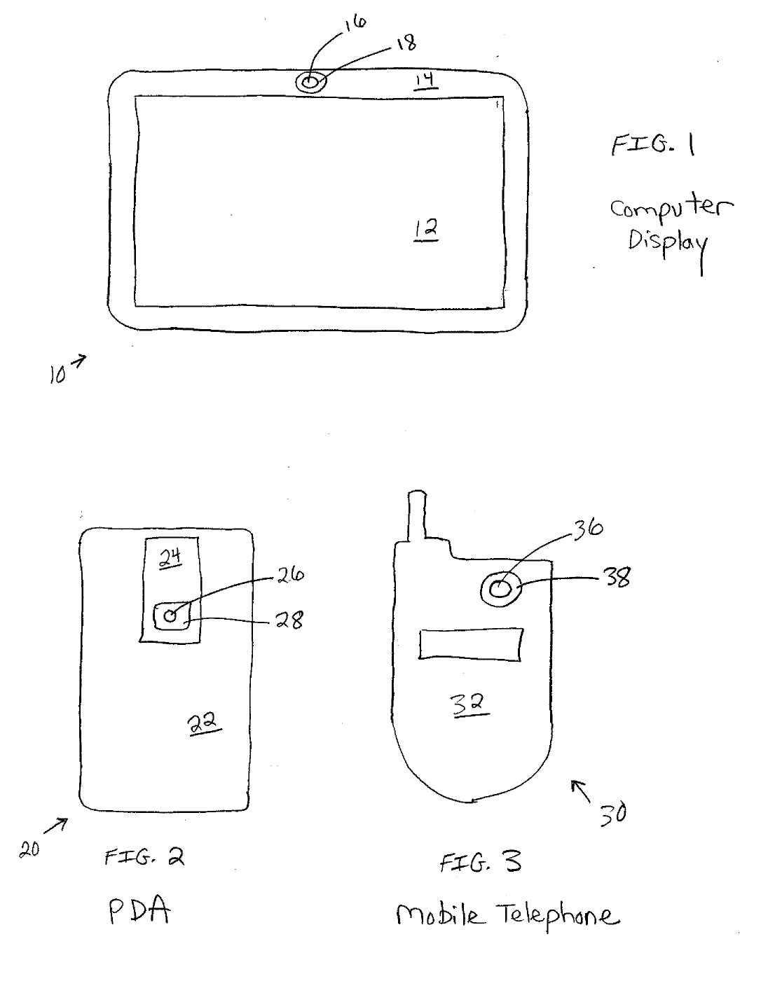

FIG. 1 illustrates a computer onto which the cover of the present invention may be mounted. The computer may be any of a wide variety of desktop or laptop computers and may include all its hardware within the display itself or separately. For ease of understanding, only the display 10 is shown. The display includes a screen area 12 where the images on the computer appear and a border area 14. Border area 14 typically is of metal, glass or plastic (or a combination of materials) and serves not only to encase the display 12 but also to provide support, protection and an area for auxiliary devices such as a camera or projector.

As shown, within border area 14 is a camera lens 16 sitting within a circular recessed area 18. The mechanism of the lens and the camera or projector itself are not shown but are understood by those of skill in the art. Lens 16 may be the lens of any suitable camera for taking still images, may be the lens of a video camera for recording videos or movies, or may be they lens of a projector for projecting images or movies from the computer onto a nearby surface. In particular, the cover may be adapted to cover one of a variety of miniature projection lenses available for computers, PDAs, mobile telephones, and smartphones. Thus, it will be understood that reference to a lens below in the various embodiments including computers, PDAs, telephones, etc., includes both a camera lens and a projection lens. In addition, the cover may fit over the lens on a wrist telephone or “wristphone.” Furthermore, while a recessed area 18 is shown, such an area need not always be present and if so, may come in a variety of shapes, not necessarily circular, and need not necessarily be recessed.

FIG. 2 illustrates a personal digital assistant (PDA) 20 or smart telephone (“smart phone”) onto which the cover of the present invention may be mounted. The device 20 may also be a standard mobile telephone that is not a flip telephone. Accordingly, device 20 has a back surface 22 and a front surface (not shown). The front surface includes the screen, keyboard, buttons etc., while the back surface 22 includes a lens 26 for taking pictures or projecting images. Lens 26 sits within a square recessed area 28, both of which are mounted within an area 24. As will be made apparent below, various embodiments of the cover may be mounted either on border area 14 or upon area 24.

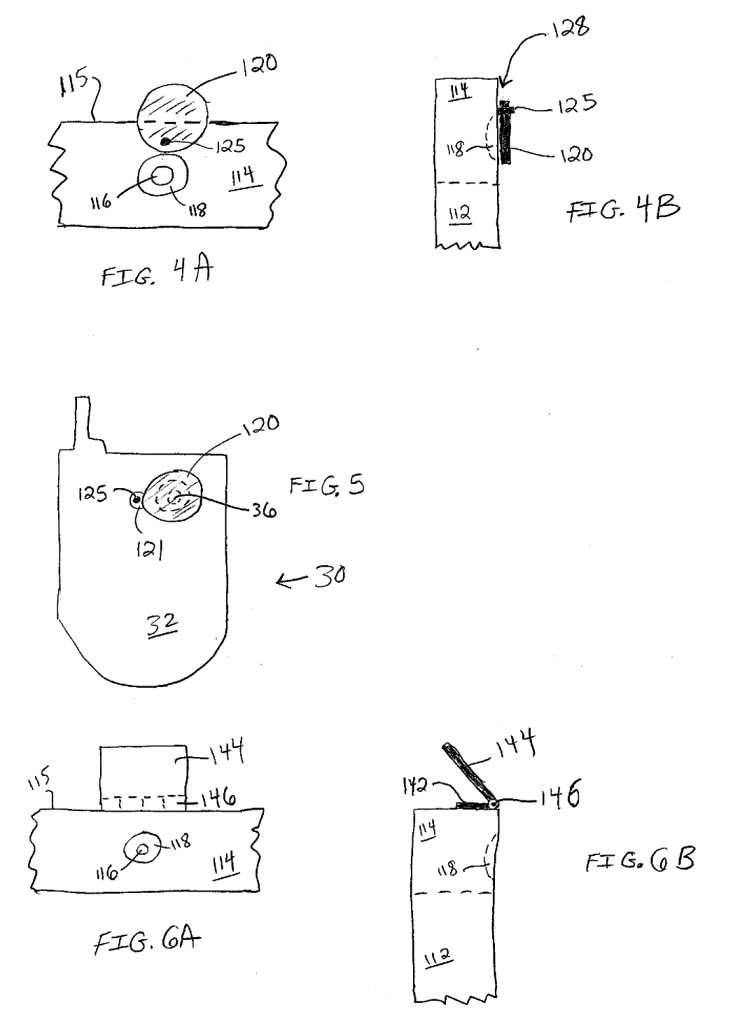

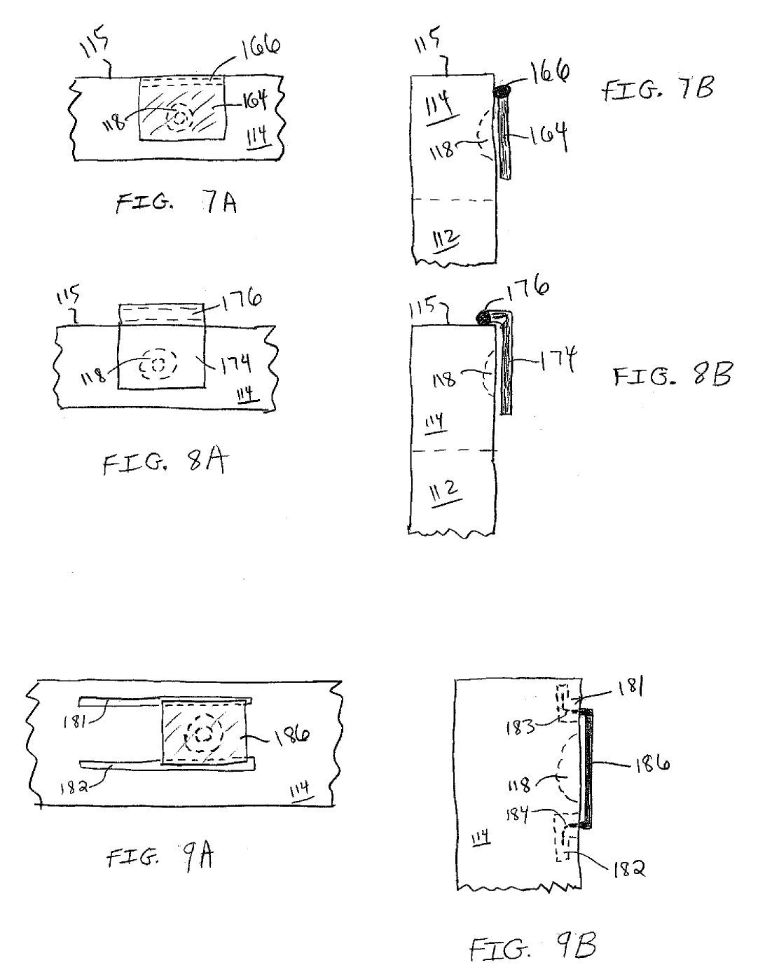

FIG. 3 illustrates a mobile telephone 30 onto which the cover of the present invention may be mounted. Telephone 30 is a “flip” telephone having a front surface 32 that is normally viewed by the user when the telephone is closed. When the telephone is in use, or when the user desires to take a picture, the telephone is flipped open and thus lens 36 faces away from the user. Lens 36 is typically mounted within a recessed area 38 and may be a still camera lens, a video lens or a projection lens.

### Cover Embodiments

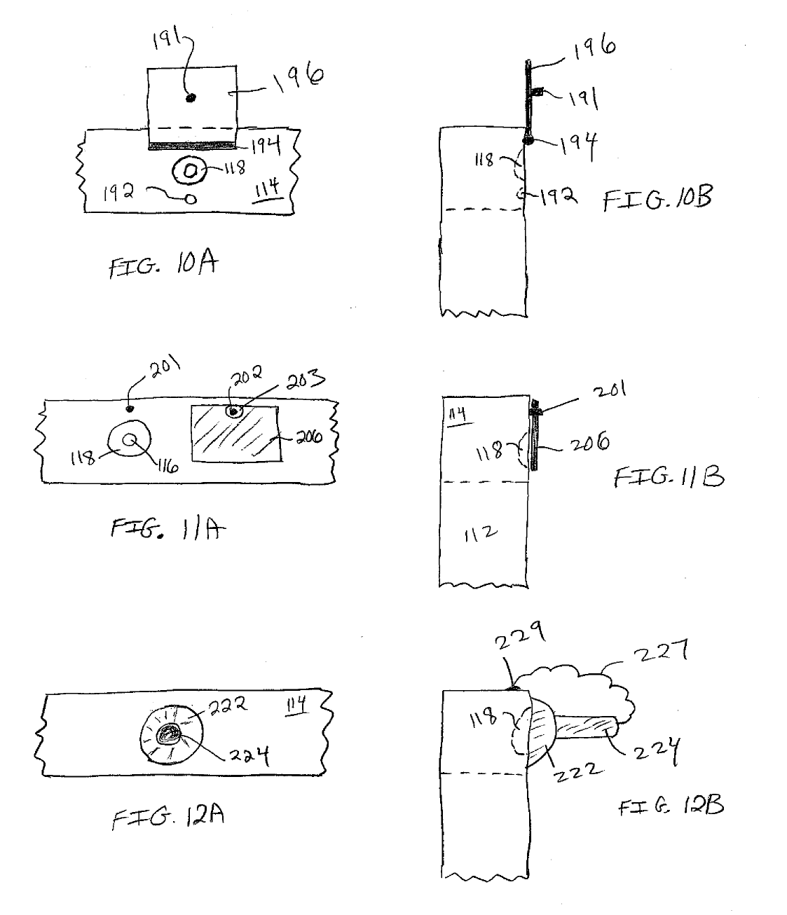

The various embodiments of the cover described below may be implemented upon the computer of FIG. 1, the PDA of FIG. 2 or the mobile telephone of FIG. 3 as will be appreciated by one of skill in the art. Although specific embodiments are shown below, one of skill will appreciate that the embodiments may be combined to produce an embodiment that is not explicitly shown. For example, the sliding cover of FIG. 9A may include a snap such as shown in FIG. 10A even know such an embodiment is not explicitly shown.

FIGS. 4A and 4B illustrate a first embodiment of the cover of the present invention in which it pivots in order to cover the lens. Shown is a border area 114 in which sits a camera lens 116 within a recessed area 118. Border area 114 may correspond to area 14 which is the top part of the display of a laptop or desktop computer, may correspond to area 24 which is a portion of the back surface of a smartphone, or may correspond to area 32 which is the front surface of a flip telephone. Edge 115 is the top edge of the border area 114 meaning that it may correspond to the top edge of display 10, the top edge of PDA 20, or the top edge of mobile telephone 30.

As shown, cover 120 includes within its circumference a pivot pin 125 that is affixed to the surface of area 114. The cover is allowed to pivot around this pin such that in the open position (as shown) the lens 116 is allowed to receive (or project) images. By fixing the cover to the surface fairly tightly with the pivot pin, friction keeps the cover open. The pivot pin is preferably made from metal or plastic and is attached to the computer and the cover using self-adhesive backing.

The user rotates the cover downward manually to cover the lens in which case the lens cannot receive outside images or project images. In the case of a laptop or desktop computer, gravity keeps the cover closed after it has been closed, although friction may also be used to keep the cover closed. In the case of a PDA 20 or telephone 30, friction is preferred to keep the cover closed. FIG. 4B is a side view of this embodiment. In the case of a laptop or desktop computer, area 112 corresponds to the screen area 12 formed below the border area 114. Shown in this view is a narrow gap 128 between the cover 120 and the surface of area 114. In this embodiment gravity easily keeps the cover closed while other means may be used to keep the cover open (such as hook and loop closures, etc.). Preferably, though, gap 128 is virtually nonexistent and friction between the cover and the surface of area 114 keeps the cover either open or closed after the user has moved it manually.

To use this embodiment, the pin is inserted through the cover and then one end of the pin (or its base) is adhered to the surface. The user rotates the cover up or down in order to uncover or cover the lens. An attachment means as described herein may be attached to the underside of the cover on the opposite side of the pin in order to attach the cover to the surface so it does not rotate when it is in place. If the cover is affixed tightly between the top of the pin and the surface than friction will hold the cover in place.

FIG. 5 illustrates a second embodiment in which the cover is mounted upon a mobile telephone 30. In this embodiment cover 120 also pivots around pivot pin 125 in order to cover or uncover lens 36. Formed as part of cover 120 is a protuberance 121 of any suitable shape that closes the pivot pin 125. Thus, the pivot pin is not within the circumference of the cover proper, as it is in FIG. 4A. In this embodiment, friction again may be used to keep the cover either open or closed.

FIGS. 6A and 6B illustrate a third embodiment in which the cover hinges in order to cover the lens. The cover includes a fixed portion 142 attached to the top of the computer, a hinge portion 146, and a movable portion 144. FIG. 6A shows a front view in which the movable portion 144 has been raised upward and the lens 116 is clear, while FIG. 6B is a side view of the same situation. When desired, the user manually moves portion 144 downward so that it hangs more or less straight down vertically and covers the camera lens. When used with a computer display 10, gravity holds the cover down. When used with PDA 20 or telephone 30, it may be necessary to fix movable portion 144 to surface 114 using hook and loop closures, a snap, a latch, or other techniques described herein. Hinge portion 146 may be a conventional pin-type hinge using rigid materials, or may simply be a crease in flexible materials such as soft plastic. The other embodiments described below in which a hinge is used may also use a pin-type hinge or a crease.

To use this embodiment a type of adhesive means on the bottom of the fixed portion is used to attach the cover to the top surface of the computer. The user then rotates the cover forward and down to cover the lens or rotates it upward to uncover the lens.

FIG. 6C illustrates a variation of this embodiment with a laptop computer. Shown is a lower portion of the computer 150, a display portion 152, a gap 153 between the two portions, and a hinge mechanism 154. Preferably, the cover is closed before closing the laptop, thus movable portion 144 is sandwiched between the lower portion 150 and the display 152 within gap 153. In this embodiment, it is preferable that the thickness of movable portion 144 is in the range of 0.0038 inch to approximately 1/16 inch, although other thicknesses will work as well, depending upon the gap between the body of the laptop and its display when closed.

To use this embodiment the user rotates the cover forward and down to cover the lens and then closes the laptop computer with the movable portion of the cover sandwiched between the top portion and the bottom portion of the laptop.

FIGS. 7A and 7B illustrate a fourth embodiment in which the cover hinges to cover the lens. Shown is a cover 164 attached to a hinge 166 that is affixed to area 114 below the top edge 115. Hinge 166 may be located substantially below the top edge or may be located flush with the top edge. As shown, the cover is closed and covers recessed area 118 and the lens within it. When used with laptop or desktop computers, gravity holds the lens closed, when used with mobile devices any of the techniques described above for fixing the cover to the body of the device may be used. When open, the cover may fold flat on top of surface 115 if hinge 166 is located flush with the top edge. If hinge 166 is located substantially below the top edge, then a fixing means would normally be needed to affix cover 164 in an open position (such as hook and loop closures, a snap, etc.) to hold the cover against surface 114. Alternatively, when used with a desktop or laptop computer in which the top edge of the display is tilted away from the user, gravity would hold the cover in an open position.

To use this embodiment a type of adhesive means on the bottom of the hinge (or on a base to which the hinge is attached) is used to attach the cover to the front surface of the computer. The user then rotates the cover down to cover the lens or rotates it upward to uncover the lens.

FIGS. 8A and 8B illustrate a fifth embodiment in which the cover hinges to cover the lens. Shown is a cover 174 attached to a hinge 176 that is affixed to area 114 on the top edge 115. In this embodiment, cover 174 has an “L” shape. As shown, the cover is closed and covers recessed area 118 and the lens within it. When used with laptop or desktop computers, gravity holds the lens closed, when used with mobile devices any of the techniques described above for fixing the cover to the body of the device may be used. When open, the cover may sit atop surface 115, resting upon the short portion of the “L” shape.

To use this embodiment a type of adhesive means on the hinge (or on a base to which the hinge is attached) is used to attach the cover to the top surface of the computer. The user then rotates the cover forward and down to cover the lens or rotates it upward to uncover the lens.

FIGS. 9A and 9B illustrate a sixth embodiment in which the cover slides back and forth in order to cover the lens. Shown is a cover 186 in a closed position covering the lens. The cover is mounted in two sliding tracks 181 and 182. Preferably, these tracks are recessed elongated cavities within the computer frame as shown in FIG. 9B. The cover 186 includes flanges 183 and 184 attached to the cover that extend inside cavities 181 and 182 in order to keep the cover in place, yet allow it to slide back and forth. As shown, each flange extends away from the center of the cover and up inside each cavity in order to hold the cover in place. The cavities and flanges may take other forms as well. For example, both cavities and flanges may extend in opposite directions (i.e., toward the center of the cover), one flange may extend away from the center of a cover and the other flange may extend toward the center of the cover, or the cavities may have different shapes. When the user desires to use the lens, the cover 186 is slid to the left. The cover may be constructed to slide to the right and left, as well as up and down.

To use this embodiment the recessed grooves are formed within the front surface of the computer or telephone. The flanges of the cover are then each inserted into their respective grooves, thus holding the cover in place. The user slides the cover in front of the lens to disable it or slides the cover away from the lens to uncover it and allow the lens to operate. Any of a variety of attachment means (snap, VELCRO, etc.) may be attached to the underside of the cover in order to hold the cover in place on the front surface of the device when it is desired that the cover not move. Alternatively, a tight fit with the flanges in the grooves (or of the cover against the surface) may create enough friction to hold the device in place until the user moves it manually.

FIGS. 10A and 10B illustrate a seventh embodiment in which the cover is fixed in place using a snap. As shown, cover 196 is mounted to the body of the computer, PDA or telephone using a hinge mechanism 194. The hinge mechanism may be as described in any of the embodiments herein or maybe any other suitable type hinge. The cover is shown in the open position. When closed, a snap is used to hold the cover closed. The snap includes a male portion 191 and a female portion 192. The snap may be a traditional snap or may be a pin type snap in which a pin 191 is inserted into recess 192, in either case, friction holds the cover in place when closed. The hinge portion 194 may be mounted below the top edge 115, flush with the top edge, or on top of the device itself as shown in previous embodiments.

To use this embodiment an adhesive is applied to one side of the hinge (or to a base on which the hinge is formed) and the assembly is adhered to the front surface of the device. A male snap is formed on the underside of the cover and the corresponding female portion is formed within the front surface of the device. The user rotates the cover downward and snaps it in place to cover the lens, and raises the cover upward to uncover the lens. Any of a variety of attachment means may be formed on the outer surface of the cover and on the front surface (above the lens) in order to hold the cover in an open position.

FIGS. 11A and 11B illustrate an eighth embodiment in which the cover mounts on a hook or pin. As shown, a cover 206 includes a hole in itself 203 and is hanging upon a hook, pin or other protuberance 202 from the computer body. In this position, the lens is open and the cover is stored out of the way. The computer (or PDA or telephone) body also includes a second hook, pin or protuberance 201 formed or mounted substantially above the lens 116. To cover the lens, the user simply removes the cover from hook 202 and places it over hook 201. Although the hook 201 is shown in the shape of a straight pin, it will be appreciated that hook 201 may take any form as long as it protrudes far enough from surface 114 in order to hook and hold cover 206 through hole 203. Further, although hole 203 is shown as being round, it may be any shape. This embodiment is most suitable for a laptop or desktop computer in which gravity holds the cover in place. Of course, any of the other embodiments shown herein describing means for holding the cover to a surface (i.e., hook and loop closure, snap, ZIPLOC, etc.) may also be used. Hooks 201 and 202 (and the other means described herein used to attach the cover to the computer) may be affixed to the computer body using self adhesive. The adhesives are preferably of the type where a paper backing is peeled off, thus exposing the adhesive. The user then applies pressure to mount the adhesive and the device to which it is attached onto the computer or telephone. Where more strength is required, a strong glue or an epoxy glue (either a one part or two part) may be applied to a portion of the cover and then the cover is installed in place.

To use this embodiment two hooks are formed on the front surface of the device or are adhered to the front surface using any of a variety of adhesives. The user places the cover on the hook above the lens in order to cover it and move the lens to the other hook to uncover it. The second hook is located far enough away from the lens such that when the cover is placed upon it the lens is not obscured.

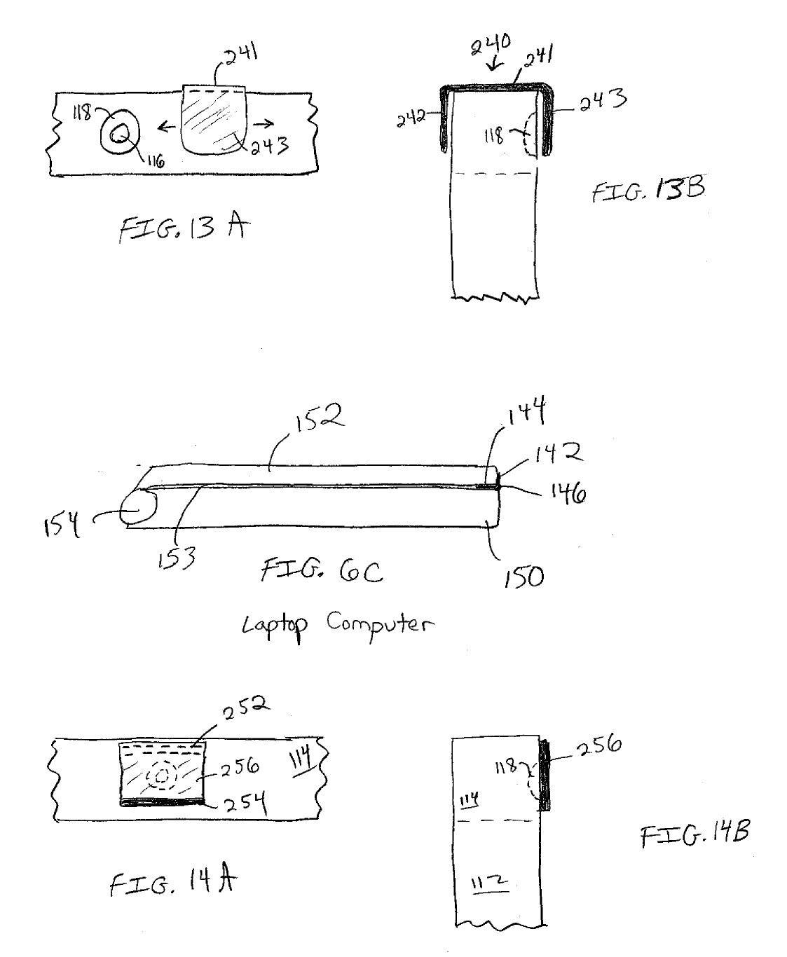

FIGS. 12A and 12B illustrate a ninth embodiment in which the cover mounts via a suction cup. As shown, a suction cup 222 is mounted to the surface 114 in order to completely cover the recessed area 118 that includes the lens. If area 118 is not recessed, than the diameter of cup 222 may be the same as area 118 or slightly smaller, as long as it substantially covers the interior lens. Suction cup 222 includes a handle or rear portion 224. Even those shown as having a clinical shape, this handle may take any of a wide variety of forms. Attached to the rear of handle 224 is a cord, string, wire or other flexible connector that mounts to the computer body using a mount 229. Although the mount is shown on top of the computer, the mount may also be on the rear of the computer or on its front surface. In order to use the lens, the user removes the suction cup from the surface and places it to one side, on top or to the rear of the computer. The suction cup may be made from rubber, vinyl or plastic, for example.

To use this embodiment a cord is attached to the rear of a suction cup and the other end of the cord is affixed (using adhesive, a snap, a screw, pressure, etc.) to the top, rear or front surface of the electronic device. The suction cup proper is then placed over the lens and force is applied to utilize suction to hold the cup in place. This embodiment works well upon a surface such as glass, metal or smooth plastic. When pulled off by the user the suction cup remains attached to the device and hangs to the side or to the back out of the way.

FIGS. 13A and 13B illustrate a tenth embodiment in which the cover slides on top of the computer. As shown, cover 240 is basically a U-shaped piece of material having a top portion 241, a rear portion 242 and a front portion 243. FIG. 13A shows the cover in an open position in which it is not covering lens 116. By sliding the cover to left the user may cover the lens to prevent it from operating. Although the cover is shown having portions 242 and 243 which are symmetrical (i.e., having the same length), it will be appreciated that these portions may have different lengths. For example, rear portion 242 need only be long enough so that it engages the rear of the computer display in order to hold the cover in place. Likewise, front portion 243 should be long enough to just substantially cover (or completely cover) the lens 116 although it of course may be longer. And, although gaps are shown between front and rear portions 242 and 243 and the body of the display, these gaps may be nonexistent in which friction operates to hold the cover in place. This cover is most suitable for the display of a laptop or desktop computer although it may be used with a PDA or mobile telephone as long as sufficient friction exists between the front and rear portions and the body of the device in order to hold cover in place.

Alternatively, the lower ends of portions 242 and 243 may include flanges that engage with recessed tracks within the display body as shown in FIG. 9B in order to hold the cover in place. In other words, the front of the display would include an elongated recessed track below the lens and the rear of the display would include a similar recessed track.

To use this embodiment the user places the cover onto the top edge of the computer, PDA or telephone. The cover may be slid in one direction to cover the lens or may be slid in the other direction to uncover the lens. Any of the variety of attachment means described herein may be used to fix the cover in one place; the attachment means is formed on the inside of the cover between the cover and the front, rear or top surface of the electronic device. The attachment means may hold the cover over the lens or out of the way to the side of the lens. To use friction, the cover is designed such that it is barely fits over the edge of the electronic device and significant force is needed to move the cover in either direction.

FIGS. 14A and 14B illustrate an 11th embodiment in which the cover is fixed in place using a ZIPLOC-type closure. As shown, cover 256 is in place covering a lens and recessed area. In this embodiment, the cover is made from a soft, pliable type of plastic or vinyl. The hinge portion 254 is formed by affixing the plastic or vinyl to the surface 114 using adhesive, and the hinge itself is formed by a crease in the plastic or vinyl. When folded up to cover the lens, the cover is affixed to the surface 114 using a ZIPLOC-type closure 252. The female portion of the closure is adhered to the surface 114 using adhesive, while the male portion is attached to the inner side of the cover itself. The female and male portions may also be switched.

To use this embodiment the hinge portion is adhered to the surface using any of the variety of adhering or attachment means described herein. The user closes the cover by moving it upward (or downward) and sealing the closure 252. To open the cover, the user unseals the closure 252 and bends the cover away from the lens.

In addition to the covers described above being mounted directly on to the computer, PDA or telephone as shown, the cover and its hinge, tracks, snap, hooks, etc., may be mounted or attached onto the case in which the computer, PDA or telephone is enclosed. For example, gluing, vulcanization, stitching, rivets, friction, snaps, and other techniques may be used to affix the cover to the case.

The cover may have all different shapes and sizes, for example, ranging from ⅝ inch square by 1/16 inch thick to 1¼ inch square by ⅛ inch thick, as well as rounds from ½ inch diameter to 1 inch in diameter. The actual size and shape will depend upon the size of the lens to be covered, the available surface area around the lens (so as not to obstruct any screen of the device), and whether the cover is for a computer display, a PDA or a mobile telephone. The size may vary widely depending upon the device and the needs of the designer.

Although the foregoing invention has been described in some detail for purposes of clarity of understanding, it will be apparent that certain changes and modifications may be practiced within the scope of the appended claims. Therefore, the described embodiments should be taken as illustrative and not restrictive, and the invention should not be limited to the details given herein but should be defined by the following claims and their full scope of equivalents.

I claim:

1. A lens cover comprising:
a lid portion sized to substantially cover a lens formed within an electronic device;
a pivot pin extending through said lid portion in a region located in close proximity to an edge of said lid portion, said pivot pin being substantially perpendicular to said lid portion, wherein said lid portion rotates about said pivot pin to a first position in which said lid portion substantially covers said lens, and wherein said lid portion rotates about said pivot pin to a second position in which said lens is not obstructed by said lid portion; and
adhering means for adhering said pivot pin to said electronic device.

2. A lens cover as recited in claim 1 further comprising:
attaching means for attaching said lid portion to said electronic device, said attaching means located on an underside of said lid portion and located substantially opposite said pivot pin.

3. A lens cover as recited in claim 1 wherein said pivot pin is located within the circumference of said lid portion.

4. A lens cover as recited in claim 1 wherein said lid portion includes a protuberance and wherein said pivot pin is located within said protuberance.

5. A lens cover as recited in claim 1 wherein said electronic device is a computer display, a personal digital assistant, or a mobile telephone.

6. A lens cover comprising:
a base portion arranged to be affixed to an electronic device;
adhering means for adhering said base portion to said electronic device;
a lid portion sized to substantially cover a lens formed within said electronic device; and
a hinge connecting said lid portion to said base portion, wherein said lid portion rotates about said hinge to a first position in which said lid portion substantially covers said lens, and wherein said lid portion rotates about said hinge to a second position in which said lens is not obstructed by said lid portion.

7. A lens cover as recited in claim 6 further comprising:
attaching means for attaching said lid portion to said electronic device, said attaching means located on an underside of said lid portion and located substantially opposite said hinge.

8. A lens cover as recited in claim 6 wherein said electronic device is a computer display, a personal digital assistant, or a mobile telephone.

9. A lens cover as recited in claim 6 wherein said lens of said electronic device is a camera lens or a projection lens.

10. A lens cover as recited in claim 6 wherein said base portion is arranged to be affixed to a surface of said electronic device that includes said lens.

11. A lens cover as recited in claim 6 wherein said lid portion is L-shaped, and wherein said base portion is arranged to be affixed to a top of said electronic device that does not include said lens.

12. An electronic device comprising:
a lens formed within a surface of said electronic device;
two parallel, recessed tracks extending on either side of said lens; and
a lid portion sized to substantially cover said lens, said lid portion including two flanges located on opposite sides, each of said flanges formed to engage one of said recessed tracks in order to hold said lid portion securely to said surface of said electronic device, wherein said lid portion slides to a first position in which said lid portion substantially covers said lens, and wherein said lid portion slides to a second position in which said lens is not obstructed by said lid portion.

13. An electronic device as recited in claim 6 wherein said electronic device is a computer display, a personal digital assistant, or a mobile telephone.

14. An electronic device as recited in claim 12 wherein said lid portion is opaque.

15. An electronic device as recited in claim 12 wherein said lid portion is translucent.

16. A lens cover kit for covering a lens of an electronic device, said kit comprising:
a lid portion sized to substantially cover a lens formed within an electronic device, said lid portion including a hole;
a first hook including first adhering means for adhering said first hook to a surface of said electronic device in proximity to said lens, wherein when said lid portion is hooked on said first hook said camera lens is obstructed by said lid portion; and
a second hook including second adhering means for adhering said second hook to said electronic device, wherein when said lid portion is hooked on said second hook said lid portion does not obstruct said camera lens.

17. A lens cover kit as recited in claim 16 further comprising:
attaching means for attaching said lid portion to said electronic device, said attaching means located on an underside of said lid portion and located substantially opposite said hole.

18. A lens cover kit as recited in claim 16 wherein said electronic device is a computer display, a personal digital assistant, or a mobile telephone.

19. A lens cover for covering a lens of an electronic device, said lens cover comprising:
a suction cup sized to substantially cover said lens formed within said electronic device, said suction cup having a front portion for attaching to a surface of said electronic device and a rear portion;
a handle portion attached to said rear portion of said suction cup;
a cord attached to said handle portion at a first end; and
an affixing means attached to the second end of said cord for affixing said cord to said electronic device.

20. A lens cover as recited in claim 19 wherein said electronic device is a computer display, a personal digital assistant, or a mobile telephone.

21. A U-shaped lens cover for covering a lens formed in a front surface of said electronic device, said lens cover comprising:
a top portion arranged to engage a top surface of said electronic device;
a rear portion extending perpendicular to said top portion from a rear edge of said top portion, said rear portion arranged to engage a rear surface of said electronic device;
a front portion extending perpendicular to said top portion from the front edge of said top portion, said front portion sized to substantially cover said lens of said electronic device when said top portion engages said top surface of said electronic device, wherein the distance between said rear portion and said front portion is greater than a thickness of said electronic device, wherein said lens cover slides to a first position in which said front portion substantially covers said lens, and wherein said lens cover slides to a second position in which said lens is not obstructed by said front portion.

22. A U-shaped lens cover as recited in claim 21 wherein said electronic device is a computer display, a personal digital assistant, or a mobile telephone.

23. A U-shaped lens cover as recited in claim 21 wherein said distance is approximately the same as said thickness of said electronic device whereby friction holds said lens cover in said first position or in said second position.

24. A lens cover as recited in claim 6 wherein a thickness of said base portion is the same or less than the distance between a base of a laptop computer and a display of said laptop computer when said laptop computer is closed.

25. A lens cover as recited in claim 7 wherein said attaching means is located in a position not coincident with said lens when said lid portion is in said closed first position.
